(19) United States
(12) Patent Application Publication
(10) Pub. No.: US 2009/0070619 A1
(43) Pub. Date: Mar. 12, 2009

(54) MULTI-CYCLE PATH INFORMATION VERIFICATION METHOD AND MULTI-CYCLE PATH INFORMATION VERIFICATION DEVICE

(76) Inventor: Shinichi Gotoh, Osaka (JP)

Correspondence Address: MCDERMOTT WILL & EMERY LLP, 600 13TH STREET, NW, WASHINGTON, DC, 20005-3096, US

(21) Appl. No.: 12/278,913

(22) PCT Filed: Jun. 4, 2007
(86) PCT No.: PCT/JP2007/061308

§ 371 Date: Aug. 8, 2008

(30) Foreign Application Priority Data
Jun. 5, 2006 (JP) 2006-156370

(51) Int. Cl. G06F 1/14

(52) U.S. Cl. 713/500

(57) ABSTRACT

For example, multi-cycle path information is extracted from a logic synthesis constraint (S101), and a multi-cycle path verification property indicating details of verification is generated (S102). Thereafter, formal verification is performed according to a gate-level netlist that is separately generated by logic synthesis according to an RTL circuit description using a logic synthesis tool, and a multi-cycle path verification property is referenced and executed, thereby performing verification of a multi-cycle path (S103). Thereby, the validity of the multi-cycle path information can be reliably and easily verified.

### TECHNICAL FIELD

The present invention relates to a method and a device for verifying the validity of multi-cycle path information indicating a multi-cycle path in which a plurality of clock cycles are required for signal propagation, in a digital circuit that is designed according to circuit functional specifications (operational specifications, design specifications).

### BACKGROUND ART

In general, digital circuits are designed according to their functional specifications, so that RTL descriptions at the Register Transfer Level (RTL) or the like are created. Logic synthesis constraints are also created according to the functional specifications, taking constraints on timing into consideration. The RTL description and the logic synthesis constraints are input to a logic synthesis tool so as to generate a gate-level netlist that satisfies the timing constraints (timing specifications).

The logic synthesis constraints include multi-cycle path designation that indicates that a signal propagation path between two points in a digital circuit is a multi-cycle path in which a plurality of clock cycles are required for signal propagation, as an exception to timing. In the absence of the multi-cycle path designation (or false path designation or the like, i.e., timing exception designation), the logic synthesis tool performs logic synthesis so that signals propagate between sequential circuits within one cycle.

The multi-cycle path designation is typically performed manually according to the functional specifications. Therefore, erroneous multi-cycle path designation is often made. In this case, a generated logic circuit may not operate appropriately, or even if it operates appropriately, its circuit scale is large due to excessive timing adjustment.

Therefore, there is a proposed verification technique in which delay information is buried in the RTL description, a multi-cycle path candidate is extracted by analyzing the delay information, and the multi-cycle path candidate is checked against separately created multi-cycle path designation (see, for example, Patent Document 1).

There is also a proposed technique of automatically detecting a multi-cycle path by analyzing a target circuit in terms of, for example, the name of each element and the meaning or relation of a signal with respect to a terminal (see, for example, Patent Document 2).

### Patent Document 1: Japanese Unexamined Patent Application Publication No. 2001-273351

### Patent Document 2: Japanese Unexamined Patent Application Publication No. 2004-171149

### DISCLOSURE OF THE INVENTION

### Problems to be Solved by the Invention

However, in the technique of burying delay information in an RTL description and analyzing it, verification is not appropriately performed if the buried delay information itself has an error, and in addition, an effort is required to bury the delay information.

In Patent Document 2, although no specific information and processes are explicitly described, it is described that a multi-cycle path is automatically detected by analyzing a target circuit in terms of the name of each element and the meaning or relation of a signal with respect to a terminal. Therefore, it is considered that a multi-cycle path is detected according to functional specifications and an RTL description. Therefore, when the RTL description itself has an error, inappropriate multi-cycle path designation is obtained.

The present invention has been attained in view of the above-described problems. An object of the present invention is to allow more reliable and easier verification of the validity of multi-cycle path information indicating a multi-cycle path in a logic circuit, the multi-cycle path information being obtained from functional specifications for the logic circuit.

### Solution to the Problems

To achieve the object, the present invention provides a method for verifying multi-cycle path information indicating a multi-cycle path in a logic circuit, the multi-cycle path information being obtained from functional specifications for the logic circuit, the method comprising:

an analysis step in which an analysis section analyzes circuit information indicating a circuit configuration based on the functional specifications; and

a verification step in which a verification section verifies validity of the multi-cycle path information based on a result of the analysis.

Here, the analysis step can be performed by, for example, formal verification, or dynamic verification in which a circuit operation is simulated.

Also, the multi-cycle path information may be extracted from a constraint (logic synthesis constraint) that is used to synthesize of the logic circuit. The multi-cycle path information after verification may be synthesized with the logic synthesis constraint.

### EFFECT OF THE INVENTION

According to the present invention, the validity of multi-cycle path information can be reliably and easily verified.

### BRIEF DESCRIPTION OF THE DRAWINGS

FIG. 1 is a circuit diagram showing an exemplary logic circuit to be verified by a multi-cycle path information verification device according to an embodiment of the present invention.

FIG. 2 is a timing chart showing an exemplary operation of a logic circuit to be verified.

FIG. 3 is a diagram for describing an exemplary RTL circuit description of a logic circuit to be verified.

FIG. 4 is a diagram for describing exemplary logic synthesis constraints.

FIG. 5 is a flowchart showing an operation of a multi-cycle path information verification device of Embodiment 1.

FIG. 6 is a diagram for describing a multi-cycle path verification property according to Embodiment 1.

FIG. 7 is a diagram for describing an exemplary verification result according to Embodiment 1.

FIG. 8 is a flowchart showing an operation of a multi-cycle path information verification device of Embodiment 2.

FIG. 9 is a diagram for describing an activation confirmation property according to Embodiment 2.

FIG. 10 is a diagram for describing an exemplary result of execution of the activation confirmation property according to Embodiment 2.

FIG. 11 is a diagram for describing an exemplary indefinite value setting property according to Embodiment 3.

FIG. 12 is a timing chart showing an example in which an indefinite value is set according to Embodiment 3.

FIG. 13 is a flowchart showing a process of obtaining a portion where multi-cycle path designation is erroneous according to Embodiment 3.

### DESCRIPTION OF THE REFERENCE CHARACTERS

FF1 to FF4 flip-flop

AND1, AND2 AND circuit

INV1, INV2 inverter

### BEST MODE FOR CARRYING OUT THE INVENTION

Here, embodiments of the present invention will be described in detail with reference to the accompanying drawings. Note that, in each embodiment below, components having functions similar to those of the other embodiments are indicated by the same reference symbols.

### EMBODIMENT 1 OF THE INVENTION

(Logic Circuit to be Verified, Etc.)

Firstly, an exemplary logic circuit or the like to be verified by a multi-cycle path information verification device according to this embodiment will be described.

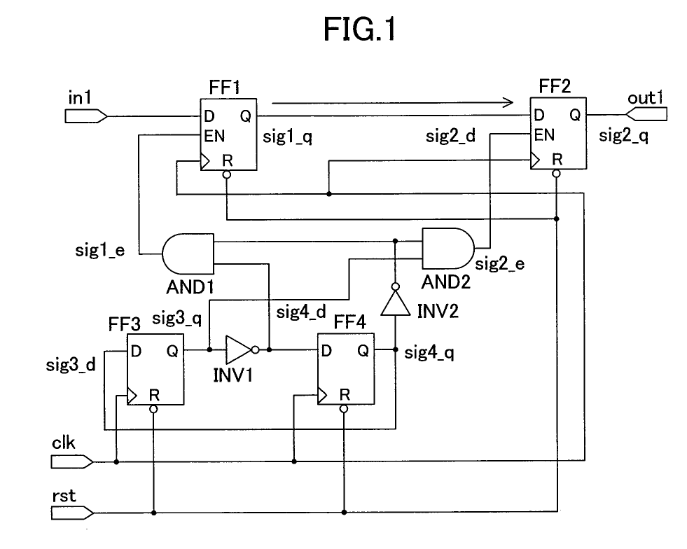

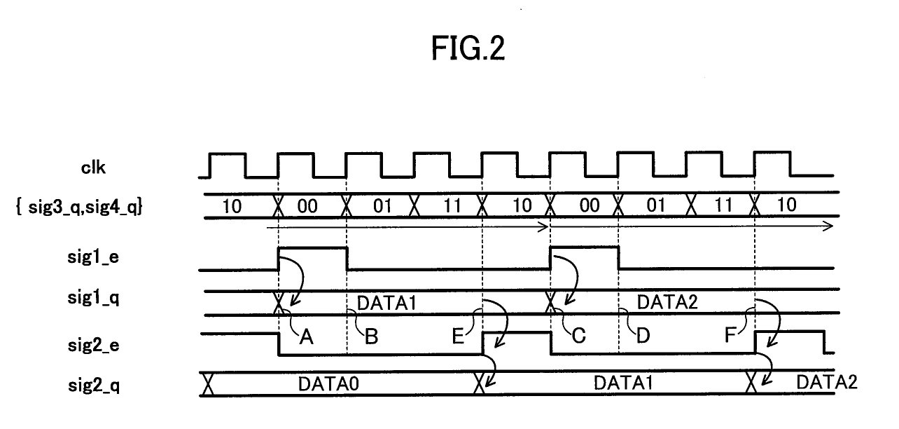

The logic circuit to be verified includes four flip-flops FF1 to FF4, two AND circuits AND1 and AND2, and two inverters INV1 and INV2 as shown in FIG. 1, for example. This logic circuit operates in synchronization with a clock signal clk after a reset signal rst goes to an L (Low) level as shown in FIG. 2. In this logic circuit, a path between outputs sig_q1 and sig_q2 of the flip-flops FF1 and FF2 is a multi-cycle path having a multi-cycle number of 3.

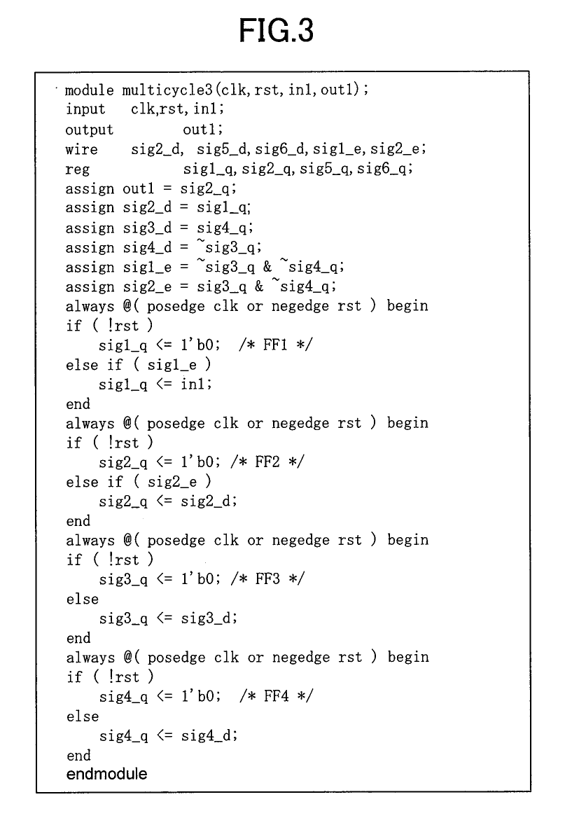

The logic circuit is represented by an RTL circuit description (e.g., a text file whose file name is multicycle3.v) as shown in FIG. 3, for example.

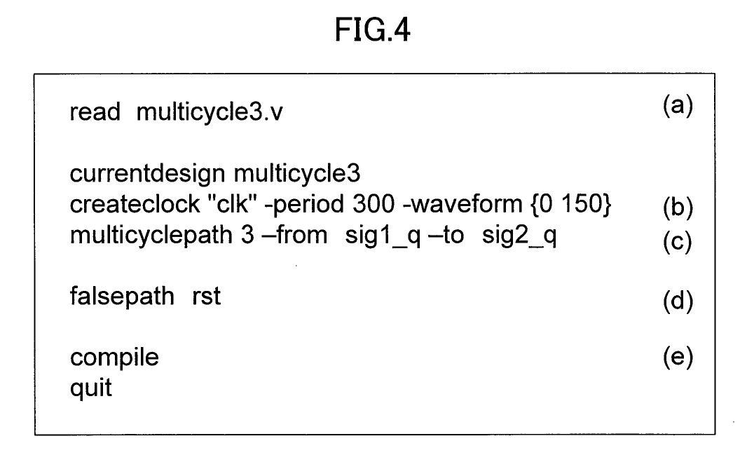

Also, multi-cycle path information to be verified in this embodiment is included in logic synthesis constraints as shown in FIG. 4, for example. The logic synthesis constraints indicate constraints on timing that is used during synthesis of a gate-level logic circuit according to the RTL circuit description or during static timing analysis. In this example of FIG. 4, rows (b) and (c) indicate signal propagation path designation and a multi-cycle number of a multi-cycle path, and a reference clock corresponding to the cycle. Specifically, it is indicated that a path from the flip-flop FF1 as a start point to the flip-flop FF2 as an end point has a multi-cycle number of 3 with respect to the clock clk. Note that rows (a) and (e) of FIG. 4 are not directly related to the multi-cycle path information, but are a circuit read command or a logic synthesis execute command that indicate instructions to a logic synthesis device. Also, row (b) is a command for designating a clock name, a clock cycle, and a phase. Further, row (d) is a command for designating that a path starting from the reset signal rst is a false path. The RTL circuit description and the logic synthesis constraints are created according to functional specifications for the logic circuit.

(Functional Configuration and Operation of Multi-Cycle Path Information Verification Device)

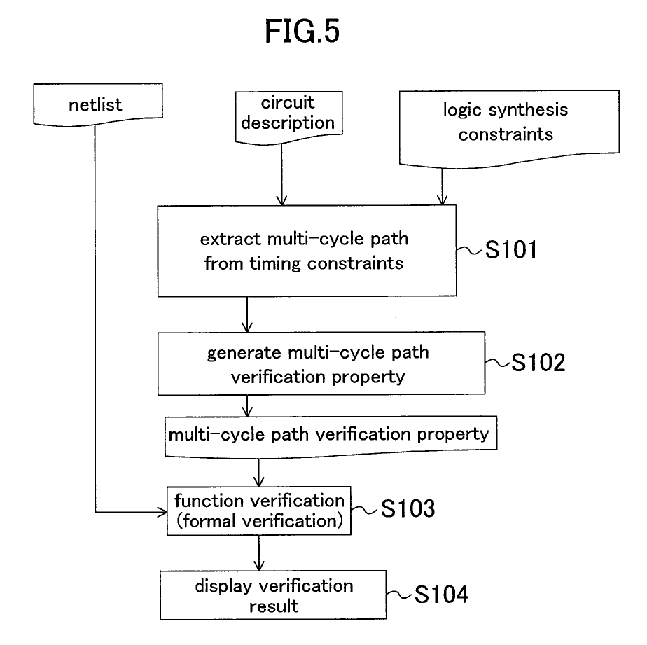

The multi-cycle path information verification device is, for example, configured by incorporating software into a computer including a CPU, a memory, a storage device, an input/output device and the like, and from a functional viewpoint, includes sections having functions of executing steps, such as those shown in FIG. 5, for example.

(S101) Initially, multi-cycle path information is extracted from the logic synthesis constraints (FIG. 4) while referencing the RTL circuit description.

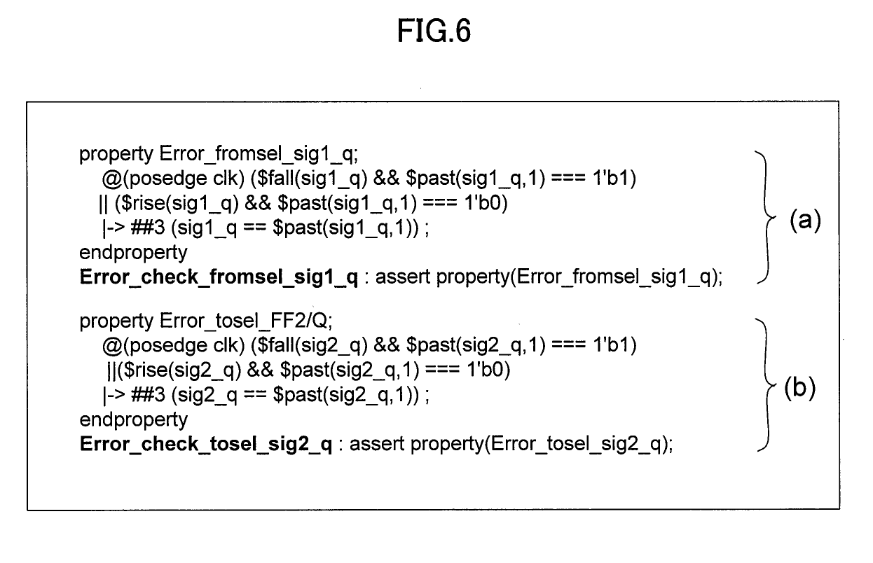

(S102) Next, a multi-cycle path verification property indicating details of verification is generated based on the extracted multi-cycle path information. Specifically, for example, information, such as that shown in FIG. 6, is generated.

Specifically, in the case of the exemplary verification property of FIG. 6, it is verified according to portion (a) that the output signal sig1_q of the flip-flop FF1 that is the start point of a multi-cycle path is a desired operation, and it is verified according to portion (b) that the output signal sig2_q of the flip-flop FF2 that is the end point of the multi-cycle path is a desired operation.

(S103) Formal verification is performed according to a gate-level netlist that is separately generated by logic synthesis according to the RTL circuit description using a logic synthesis tool. In this case, the multi-cycle path is verified by referencing and executing the multi-cycle path verification property.

More specifically, for example, for the flip-flop FF1, a verification property @(posedge clk) indicates a sampling timing of a following evaluation expression. The evaluation expression is evaluated at a timing of rising of the clock signal clk. A portion of the following evaluation expression, i.e., ($fall(sig1_q)&&$past(sig1_q, 1)===1′b1)∥($rise(sig1_q)&&$past(sig1_q, 1)===1′b0), indicates conditions for evaluation. A signal value of sig1_q at a sampling timing one cycle before is held and compared, so that the occurrence of a signal change during a current cycle is detected. More specifically, a falling edge of sig1_q is detected by a term before a logical OR operator ∥ in the evaluation expression, and a rising edge of sig1_q is detected by a term after the logical OR operator ∥. In other words, the logical OR operation detects changes both in rising and falling edges (e.g., timings A and C in FIG. 2), and an evaluation expression in the next term is evaluated.

In the evaluation expression in the next term |->##3 (sig1_q==$past (sig1_q, 1), it is detected whether or not a value of sig1_q one cycle before is constant for a period of time of no less than three cycles that correspond to the multi-cycle number (e.g., a period of time from B to C in FIG. 2).

Similarly, for the flip-flop FF2, it is detected whether or not a value of sig2_q is constant for a period of time of no less than three cycles that correspond to the multi-cycle number. Since the determination of FF2 is also performed as described above, it can be detected that the output of FF2 changes with timing of less than the multi-cycle path number by providing a gate between FF1 and FF2, for example.

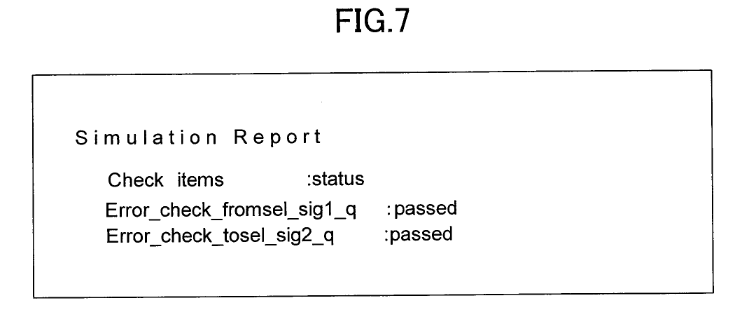

(S104) When the verification detects that both sig1_q and sig2_q are constant for no less than three cycles, it is verified that the multi-cycle path information included in the logic synthesis constraint (FIG. 4) matches the netlist (i.e., the RTL circuit description), so that a message, such as that shown in FIG. 7, is displayed on a display device (not shown), for example.

(Exemplary Case where Mismatch Occurs)

For the logic circuit of FIG. 1 (the RTL circuit description of FIG. 3), if it is, for example, assumed that multi-cycle path information indicating that the multi-cycle number is four is included in the logic synthesis constraints, it is determined in (S103) in a manner similar to that described above whether or not the level of each of the signals sig1_q and sig2_q may change for a period of time of four cycles, i.e., from B to D in FIG. 2. In this example, however, since a change may occur at a timing C of FIG. 2, i.e., the level of each of the signals sig1_q and sig2_q is not necessarily constant for a period of time of four cycles or more, a path between the signals sig1_q and sig2_q is erroneous, so that it is determined that the multi-cycle path information does not match the netlist.

Note that, actually, D that is four cycles after B is a timing after the time C when evaluation, such as that described above, is performed. Therefore, at the time C, for example, information indicating that evaluation should be performed again at the time D may be held, and evaluation may be subsequently performed. Also, it may be determined that the multi-cycle number cannot be logically four by determining whether or not a change has occurred for a period of time from C to A that is four cycles before C or by determining that the number of cycles from A at which a change preciously occurred to C is four or more, for example. Further, evaluation, such as that described above, may be performed at each rising and/or falling edge of a sampling clock, thereby making it possible to increase the detection frequency. Alternatively, evaluation may be performed only at a timing(s) at which an error is (highly) likely to be detected, thereby reducing the load of a simulation operation, for example.

On the other hand, it may be assumed that the multi-cycle path information indicates that the multi-cycle path is two. In this case, the level of each of the signals sig1_q and sig2_q invariably does not change for two cycles, i.e., from B to E and from D to F in FIG. 2, so that an error does not occur. In other words, when such multi-cycle path information is set, a logically synthesized circuit itself appropriately operates, though it is possible that an element having high drive capability is used to perform logic synthesis so that a delay between sig1_q and sig2_q is two cycles.

Note that formal verification is performed according to a logic synthesized netlist in the above example, or alternatively, may be performed according to an RTL circuit description, for example.

### EMBODIMENT 2 OF THE INVENTION

An example will be described in which function verification is performed by simulation of a circuit operation, thereby verifying a multi-cycle path. Here, as function verification (FIG. 5, S103) in the above-described Embodiment 1, a test patter, such as a netlist, an RTL circuit description or the like, is provided and dynamic simulation may be performed. A further example will be described below in which the reliability of a verification result is confirmed.

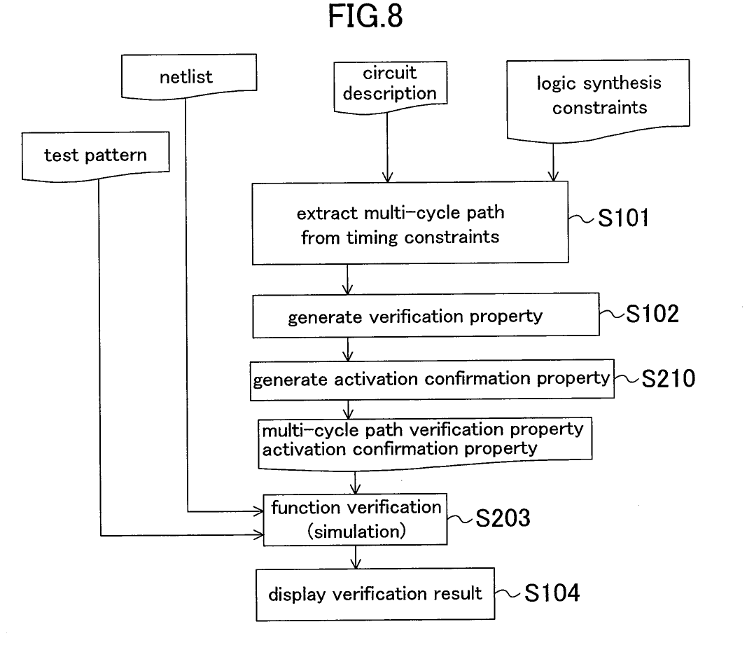

In Embodiment 2, the same operations as those in Embodiment 1 (FIG. 5) are performed in (S101), (S102) and (S104), but in (S203), a change in a signal level in each portion is obtained by simulation (dynamic verification) of a circuit operation when a signal indicated by a test pattern is input to a logic circuit, as shown in FIG. 8. As is similar to Embodiment 1, verification of multi-cycle path information according to a verification property is performed, depending on a change in the obtained signal level.

Here, it is ideal that the test pattern encompasses signal patterns that are actually input to a logic circuit. However, when simulation is performed only with respect to a representative pattern, reliable verification is not necessarily performed. For example, in the case of verification of multi-cycle path information, if a cycle of changes in a signal input to a multi-cycle path is longer than the multi-cycle number, a verification operation is not reliably activated, so that it is highly likely to be erroneously determined that there is a match. Therefore, in this embodiment, the reliability of a verification result can be confirmed by counting inputs of a signal having a cycle shorter than a multi-cycle number into a multi-cycle path.

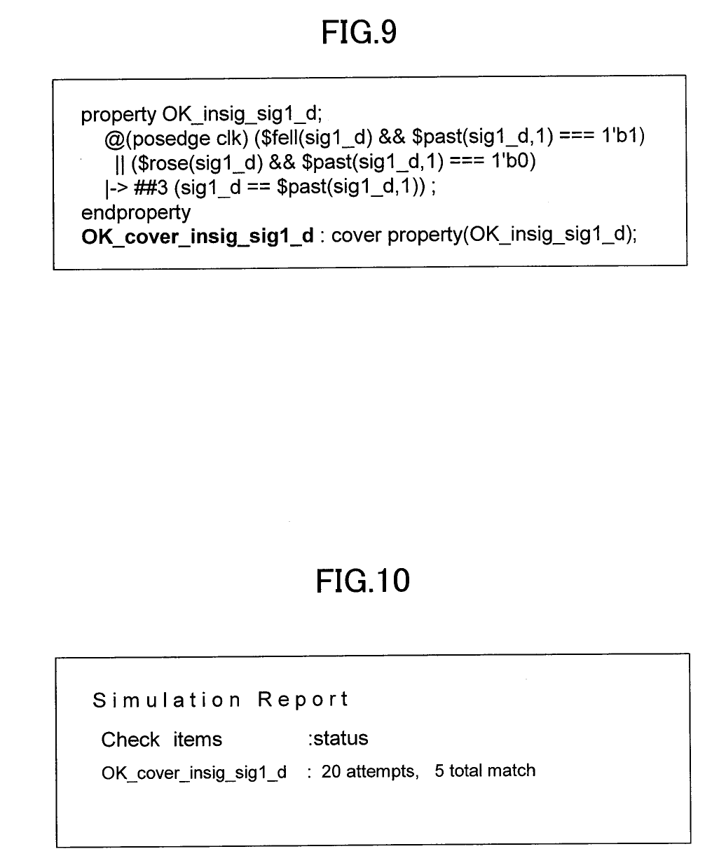

Specifically, initially, when a verification property is generated in (S102), an activation confirmation property, such as that shown in FIG. 9, is generated in (S210). In this example, the activation confirmation property indicates counting of inputs for a verification time of a signal (effective signal) having a cycle (less than three cycles) shorter than a multi-cycle number in a signal input to a start point sig1_d(in1) in a multi-cycle path.

In (S203), verification is performed according to a verification property as in Embodiment 1, and the number of inputs of an effective signal is counted according to the activation confirmation property. The counting result indicates that five effective signals occurred in 20 evaluations in (S104) as shown in FIG. 10, for example. Note that the counting method is not limited to that described above, and may be any method with which information with which the reliability of verification can be confirmed is obtained, such as the number of clock cycles in an effective signal, the proportion of an input time of an effective signal with respect to a total verification time, or the like.

Note that simulation is performed according to a logic synthesized netlist in the example above, and may be performed according to an RTL circuit description.

### EMBODIMENT 3 OF THE INVENTION

Even when simulation, such as that described above, is performed, it may not be possible to detect an input operation of a succeeding flip-flop that is performed after a period of time longer than a multi-cycle number has been passed. In other words, an output signal level of each circuit element typically has a certain definite value. Therefore, even if a period of time longer than a multi-cycle number has been passed, an input operation itself of a succeeding flip-flop is performed. Therefore, it is difficult to find an error, such as that described above, based on the result of simulation.

Therefore, by forcedly setting a signal after a period of time longer than a multi-cycle number has been passed to have an indefinite value (a value indicating neither an H (High) level nor an L (Low) level), an error, such as that described above, can be easily detected based on a signal that is output as a result of simulation from a logic circuit (final output stage).

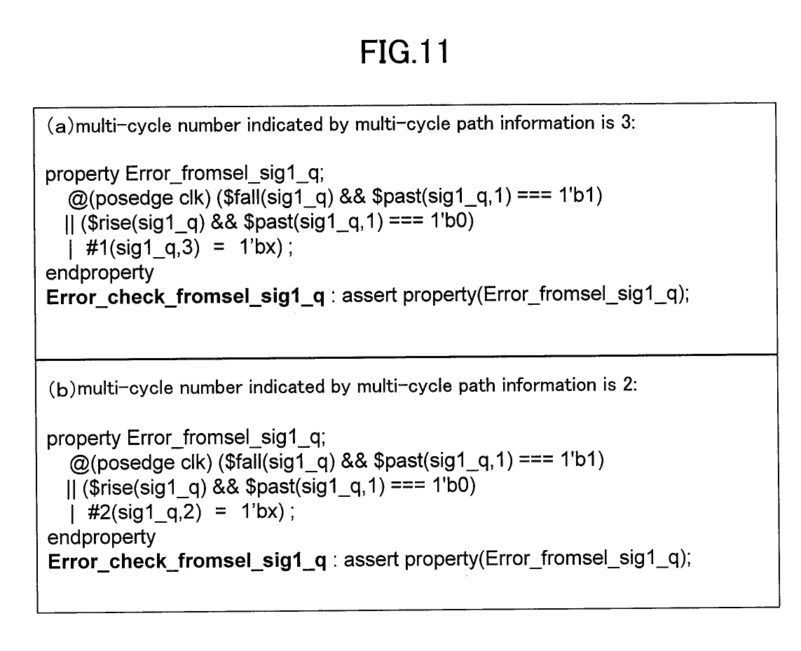

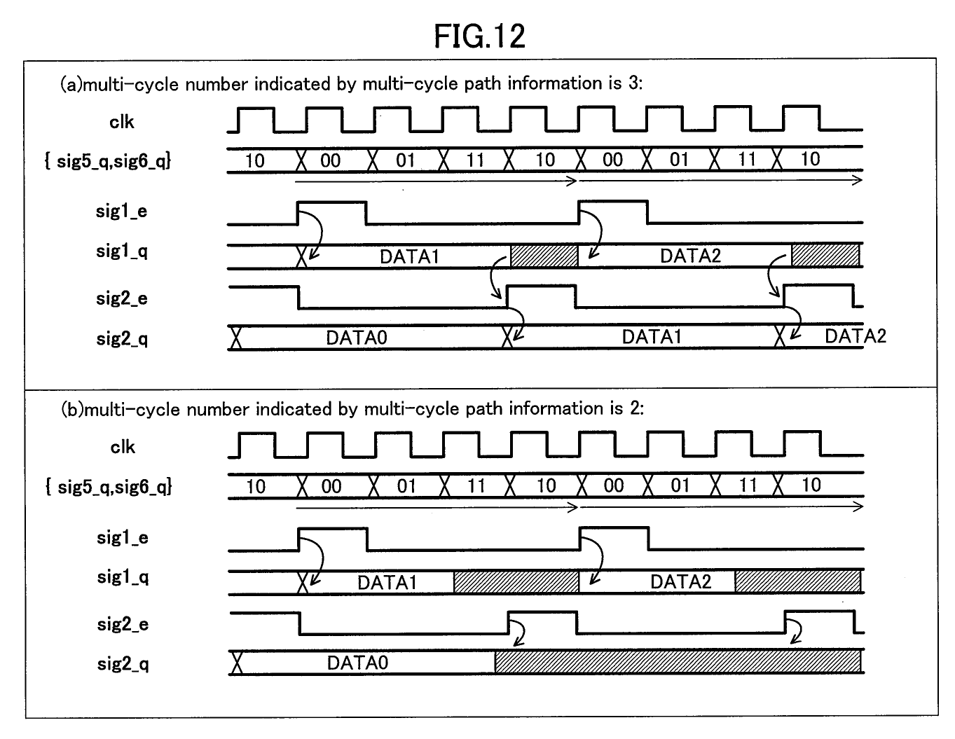

Specifically, for example, as in the case of the verification property or the activation confirmation property of Embodiments 1 and 2, an indefinite value setting property, such as that shown in FIG. 11(a), is generated. If the indefinite value setting property is referenced and executed during function verification, #1(sig1_q, 3)=1′bx is evaluated at the same timing when an evaluation expression for the verification property is evaluated (timing when a change edge of sig1_q is detected), and three cycles after detection of the change edge (sig1_q, 3), an indefinite value (1′bx) is substituted into sig1_q over one cycle width (#1), as shown in FIG. 12(a). In this case, since the multi-cycle number is three and the multi-cycle path information matches the netlist, the indefinite value is not output as the output signal sig2_q of the flip-flop FF2.

On the other hand, for example, if it is assumed that a multi-cycle number designated by multi-cycle path information is two, an indefinite value setting property, such as that shown in FIG. 11(b), is generated, and two cycles after detection of a change edge of sig1_q (sig1_q, 2), an indefinite value (1′bx) is substituted into sig1_q over two cycle widths (#2), as shown in FIG. 12(b). Therefore, if the indefinite value is latched by the flip-flop FF2, is propagated to the output signal sig2_q or the like, and is output from the logic circuit, an error, such as that a multi-cycle path is set to be short, can be confirmed.

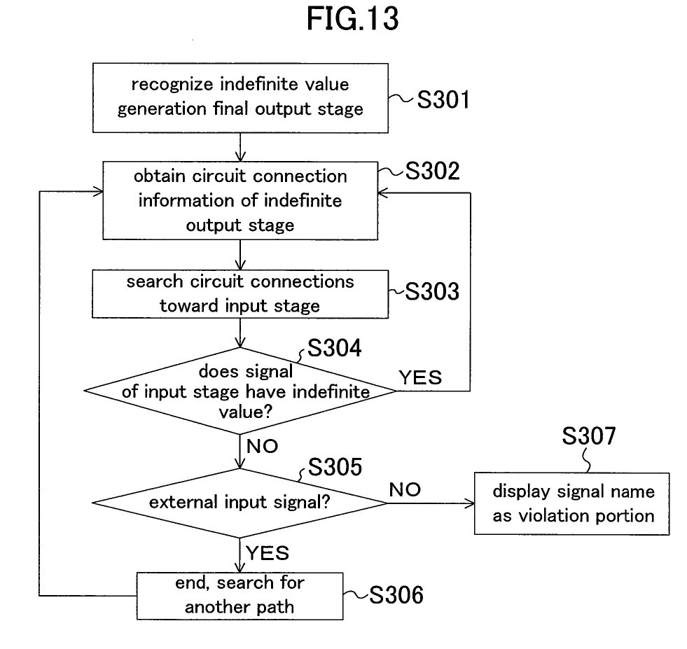

When an indefinite value is output to the outside from a logic circuit by simulation during function verification as described above, a portion of the logic circuit where a multi-cycle path is erroneously designated is found by a process, such as that shown in FIG. 13, for example.

(S301) A signal name of a final output stage in a logic circuit from which an indefinite value is output is recognized.

(S302) Starting from the recognized signal name, a signal connection path in the logic circuit is obtained based on connection information.

(S303) Circuit connections are searched toward an input stage based on the obtained connection information.

(S304) It is determined whether or not a single of the input stage has an indefinite value. If the signal has an indefinite value, a signal propagation path is traced back by repeatedly performing (S302) to (S304).

(S305) If the signal of the input stage does not have an indefinite value, it is determined whether or not the signal is a signal that is input from the outside of the logic circuit.

(S306) If it is determined in (S305) that the signal is a signal that is input from the outside, it is considered that the occurrence of output of the indefinite value is due to direct inputting of the indefinite value from an external signal, but not due to the multi-cycle path indefinite value setting property, and the process is ended with respect to the current path. Another path is searched for, and (S302) and thereafter are repeated.

(S307) Also, if it is determined in (S305) that the signal is not a signal that is input from the outside, it is considered that the signal is a signal obtained by latching an indefinite value due to an error in multi-cycle path designation, which is displayed on a display device (not shown).

### EMBODIMENT 4 OF THE INVENTION

A configuration, such as that described in Embodiment 1 or 2, and a configuration, such as that described in Embodiment 3, may be combined together.

Thereby, if the determination of Embodiment 1 or 2 is positive and the determination of Embodiment 3 is also positive, it can be determined in a comprehensive manner that multi-cycle path information matches (highly likely) circuit information indicating a circuit configuration. In other words, a multi-cycle path number indicated by the multi-cycle path information is not excessively large, and therefore, an actual circuit produced by this normally operates even if a delay corresponding to this occurs. In addition, the multi-cycle path number is not excessively small, and therefore, it is highly likely that the actual circuit does not excessively suppress a delay.

Also, when only either of them is positive, it is determined in a comprehensive manner that multi-cycle path information is likely to be excessively large or small. Therefore, the multi-cycle path information can be efficiently confirmed, modified or the like.

### INDUSTRIAL APPLICABILITY

The method and device for verification of multi-cycle path information according to the present invention have the effect of allowing reliable and easy verification of the validity of the multi-cycle path information, and are useful as a multi-cycle path information verification method and device or the like for verification of the validity of multi-cycle path information indicating a multi-cycle path that requires a plurality of clock cycles for signal propagation in a digital circuit that is designed according to operational specifications for a circuit.

1. A method for verifying multi-cycle path information indicating a multi-cycle path in a logic circuit, the multi-cycle path information being obtained from functional specifications for the logic circuit, the method comprising:
an analysis step in which an analysis section analyzes circuit information indicating a circuit configuration based on the functional specifications; and
a verification step in which a verification section verifies validity of the multi-cycle path information based on a result of the analysis.

2. The multi-cycle path information verification method of claim 1, wherein
the multi-cycle path information includes information indicating a multi-cycle number that is acceptable for signal propagation in each multi-cycle path,
the analysis step analyzes timing of a change in a signal in each multi-cycle path, and
the verification step determines that the circuit information does not match the multi-cycle path information when the signal in each multi-cycle path changes with timing different from the multi-cycle number.

3. The multi-cycle path information verification method of claim 2, wherein
the analysis step analyzes the signal change timing by performing formal verification based on the circuit information.

4. The multi-cycle path information verification method of claim 2, wherein
the analysis step analyzes the signal change timing by simulating a circuit operation based on a test pattern of a signal input to the logic circuit.

5. The multi-cycle path information verification method of claim 4, further comprising:
an input signal change detection step of detecting whether or not a signal input to the multi-cycle path changes with timing shorter than the multi-cycle number.

6. The multi-cycle path information verification method of claim 5, wherein
the signal change detection step obtains a value corresponding to the number of changes with timing shorter than the multi-cycle number.

7. The multi-cycle path information verification method of claim 4, further comprising:
an indefinite level setting step of setting a signal level after the multi-cycle number to be an indefinite level when a signal in the multi-cycle path does not change for a period of time longer than the multi-cycle number.

8. The multi-cycle path information verification method of claim 7, further comprising:
an indefinite level setting signal detection step of, when a signal having an indefinite level is output from the logic circuit, tracing back a propagation path of the signal having the indefinite level and detecting a signal set to have an indefinite level by the indefinite level setting step.

9. The multi-cycle path information verification method of claim 1, further comprising:
an extraction step of extracting the multi-cycle path information included in a constraint for synthesis of the logic circuit.

10. The multi-cycle path information verification method of claim 1, further comprising:
a synthesis step of synthesizing the multi-cycle path information with a constraint for synthesis of the logic circuit.

11. A device for verifying multi-cycle path information indicating a multi-cycle path in a logic circuit, the multi-cycle path information being obtained from functional specifications for the logic circuit, the device comprising:
an analysis section for analyzing circuit information indicating a circuit configuration according to the functional specifications; and
a verification section for verifying validity of the multi-cycle path information based on a result of the analysis.
